(19) United States
(12) Patent Application Publication
(10) Pub. No.: US 2008/0017521 A1
(43) Pub. Date: Jan. 24, 2008

(54) PROCESS CONTROL IN ELECTRO-CHEMICAL MECHANICAL POLISHING

(76) Inventors: ANTOINE P. MANENS, Palo Alto, CA (US); Stan D. Tsai, Fremont, CA (US); Liang-Yuh Chen, Foster City, CA (US)

Correspondence Address: PATTERSON & SHERIDAN, LLP, 3040 POST OAK BOULEVARD, SUITE 1500, HOUSTON, TX, 77056, US

(21) Appl. No.: 11/828,937

(22) Filed: Jul. 26, 2007

Related U.S. Application Data
(63) Continuation of application No. 10/391,324, filed on Mar. 18, 2003.

(51) Int. Cl. B23H 3/00

(52) U.S. Cl. 205/645

(57) ABSTRACT

The present invention relates to method and apparatus for determining removal rate and polishing endpoint of electropolishing process. One embodiment provides a method for determining an amount of material removed from a substrate. The method comprises providing a counter electrode and a conductive polishing article disposed over the counter electrode, contacting the substrate with the conductive polishing article so that the substrate is electrically connected to the conductive polishing article, distributing an electrolyte to the substrate and the counter electrode, and polishing one or more conductive materials on the substrate by applying a bias between the conductive polishing article and the counter electrode. The method further comprises determining a total charge removed from the substrate, and correlating the total charge removed and a thickness of material removed from the substrate.

### CROSS-REFERENCE TO RELATED APPLICATIONS

This application is a continuation of co-pending U.S. patent application Ser. No. 10/391,324, filed Mar. 18, 2003, which is herein incorporated by reference.

### BACKGROUND OF THE INVENTION

1. Field of the Invention

The present invention generally relates to polishing, planarization, plating and combinations thereof. More particularly, the invention relates to the monitoring and control of electro chemical mechanical polishing, electropolishing and plating.

2. Description of the Related Art

Sub-quarter micron multi-level metallization is one of the key technologies for the next generation of ultra large-scale integration (ULSI). The multilevel interconnects that lie at the heart of this technology require planarization of interconnect features formed in high aspect ratio apertures, including contacts, vias, trenches and other features. Reliable formation of these interconnect features is very important to the success of ULSI and to the continued effort to increase circuit density and quality on individual substrates and die.

In the fabrication of integrated circuits and other electronic devices, multiple layers of conducting, semiconducting, and dielectric materials are deposited on or removed from a surface of a substrate. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electro-chemical plating (ECP).

As layers of materials are sequentially deposited and removed, the uppermost surface of the substrate may become non-planar across its surface and require planarization. An example of a non-planar process is the deposition of copper films with the ECP process in which the copper topography simply follows the already existing non-planar topography of the wafer surface, especially for lines wider than 10 microns. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical Mechanical Planarization, or Chemical Mechanical Polishing (CMP), is a common technique used to planarize substrates. CMP utilizes a chemical composition, typically a slurry or other fluid medium, for selective removal of materials from substrates. In conventional CMP techniques, a substrate carrier or polishing head is mounted on a carrier assembly and positioned in contact with a polishing pad in a CMP apparatus. The carrier assembly provides a controllable pressure to the substrate, thereby pressing the substrate against the polishing pad. The pad is moved relative to the substrate by an external driving force. The CMP apparatus affects polishing or rubbing movements between the surface of the substrate and the polishing pad while dispersing a polishing composition to affect chemical activities and/or mechanical activities and consequential removal of materials from the surface of the substrate.

Another planarization technique is Electro Chemical Mechanical Polishing (ECMP). ECMP techniques remove conductive materials from a substrate surface by electrochemical dissolution while concurrently polishing the substrate with reduced mechanical abrasion compared to conventional CMP processes. The electrochemical dissolution is performed by applying a bias between a cathode and a substrate surface to remove conductive materials from the substrate surface into a surrounding electrolyte. Typically, the bias is applied by a ring of conductive contacts to the substrate surface in a substrate support device, such as a substrate carrier head. Mechanical abrasion is performed by positioning the substrate in contact with conventional polishing pads and providing relative motion there between.

An objective of polishing is to remove a predictable amount of material. Accordingly, any polishing technique requires an endpoint detection to determine when the appropriate amount of material has been removed. However, the progress of the polishing operation is not easily viewable because of the contact between the substrate and the pad.

In addition, variations in the polishing conditions impede an accurate determination of the polishing endpoint. Variations in the slurry/electrolyte composition, pad condition, relative speed between the pad and the substrate, and the load of the substrate on the pad, etc . . . , cause variations in the material removal rate, which change the time needed to reach the polishing endpoint. Therefore, the polishing endpoint cannot be estimated merely as a function of polishing time.

One approach to predict the polishing endpoint is to remove the substrate from the polishing apparatus and measure the thickness of the remaining film on the substrate. Doing so periodically during polishing, the quantity of material being removed from the substrate may be determined. As such, a linear approximation of the material removal rate may be used to determine the polishing endpoint. However, this method is time consuming, and does not account for sudden changes in the removal rate that may occur between measurement intervals.

Several non-invasive methods of endpoint detection are known. One type of endpoint detection typically requires access to at least a portion of the substrate surface being polished, such as by sliding a portion of the substrate over the edge of the polishing pad or through a window in the pad, and simultaneously analyzing the exposed portion of the substrate. For example, where polishing is used to expose metal lines embedded in a dielectric layer, the overall or composite reflectivity of the surface being polished changes as the lines are exposed. By monitoring the reflectivity of the polished surface or the wavelength of light reflected from the surface, the exposure of the lines through the dielectric layer, and thus the polishing endpoint, can be detected. However, this method does not provide a way of determining the polishing endpoint unless an underlying layer is exposed during polishing. Additionally, this approach is somewhat erratic in predicting the polishing endpoint unless all of the underlying lines are simultaneously exposed. Furthermore, the detection apparatus is delicate and subject to frequent breakdown caused by the exposure of the measuring or detecting apparatus to the slurry or electrolytic fluid.

A second type of method for determining the polishing endpoint monitors various process parameters, and indicates an endpoint when one or more of the parameters abruptly change. For example, the coefficient of friction at the interface of the polishing pad and the substrate is a function of the surface condition of the substrate. Where an underlying material different from the film being polished is exposed, the coefficient of friction will change also. This affects the torque necessary to provide the desired polishing pad speed. By monitoring this change, the endpoint may be detected.

In an ideal system, where no parameter other than the substrate surface changes, process parameter endpoint detection is acceptable. However, as the substrate is being polished, the pad condition and the slurry/electrolyte composition at the pad-substrate interface also change. Such changes may mask the exposure of the underlying metal layer, or they may imitate an endpoint condition, leading to a premature stop of polishing.

Finally, ECMP presents a chemically, electrically and physically unique environment, with respect to conventional CMP. Thus, while the endpoint detection techniques (including those described above) exist for CMP, the techniques may not be readily extendible to ECMP. Even where the techniques are extendible to ECMP, doing so may require retrofitting existing processing systems with expensive equipment. A preferred approach would mitigate or avoid the challenges with retrofitting existing systems.

Therefore, there is a need for polishing endpoint detection which accurately and reliably determines when to cease polishing, particularly for ECMP.

### SUMMARY OF THE INVENTION

Aspects of the invention are generally directed to determining removal of material from a substrate during polishing and to determining an endpoint of a polishing cycle.

One embodiment provides a method for determining an amount of material removed from a substrate. The method comprises electropolishing one or more conductive materials on a substrate; determining a total charge removed from the substrate during the course of polishing the substrate; and correlating the total charge removed to a thickness of material removed from the substrate.

Another method provides for determining an endpoint of a polishing cycle for a substrate. The method comprises providing a cell body defining an electrolyte-containing volume, wherein the electrolyte-containing volume contains at least electrolyte; positioning a substrate in contact with a polishing pad at least partially submersed in the electrolyte; electropolishing one or more conductive materials on the substrate; and determining the endpoint of the polishing cycle for the substrate based on the total charge removed from the substrate. Determining the endpoint comprises determining the total charge removed from the substrate; correlating the total charge removed to a thickness of material removed from the substrate; determining whether a pre-measured initial thickness of the substrate, less the thickness of material removed, is equal to or less than a selected target thickness of the substrate.

Yet another embodiment provides a computer readable medium containing a program which, when executed, performs an operation during an electropolishing process occurring for a substrate in contact with a polishing pad at least partially submersed in electrolyte. The operation comprises summing a plurality of measured current values of an electrical signal provided to the substrate to calculate a total charge value, wherein the measured current values correspond to measurements made periodically since initiating a polishing cycle for the substrate; and using the total charge value to determine a thickness of material removed from the substrate during the polishing cycle.

Still another embodiment provides an electro-chemical mechanical polishing system, comprising: a cell body defining an electrolyte-containing volume; a polishing pad disposed in the electrolyte-containing volume; a power supply configured to supply an electrical signal to electrolyte contained in the electrolyte-containing volume; and an endpoint detector configured to detect a polishing endpoint based on the total charge removed from the substrate. To this end, the endpoint detector is configured to perform an operation comprising determining a total charge removed from the substrate; correlating the total charge removed to a thickness of material removed from the substrate; determining whether a pre-measured initial thickness of the substrate, less the thickness of material removed, is equal to or less than a selected target thickness of the substrate.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings

It is to be noted, however, that the appended drawings illustrate only typical embodiments of this invention and are therefore not to be considered limiting of its scope, for the invention may admit to other equally effective embodiments

FIG. 1 is a side cross-sectional view of electropolishing system configured with a controller and endpoint detector.

FIG. 2 is a top view of an exemplary polishing pad which allows for zone control.

FIG. 3 is a top view of another exemplary polishing pad which allows for zone control.

FIGS. 4A-C are a series of side cross-sectional views of a substrate and a polishing pad illustrating a polishing cycle.

FIG. 5 is a graph showing that the area under a current signal curve represents the material removed by electrochemical polishing and any leakage current.

FIG. 6 is a generic graphical representation of a relationship between total charge removed and total material removed by electrochemical polishing.

FIG. 7 is a graphical illustration of the current/removal rate relationship, where the y-axis is the removal rate of copper and the x-axis is the total current (offset due to leakage current).

FIG. 8 is a calibration curve for a series of wafers processed at different conditions relating average current to average removal rate.

FIG. 9 shows one example of an empirically determined curve relating total charge and material removed.

### DETAILED DESCRIPTION OF THE PREFERRED EMBODIMENT

The present invention provides systems and methods for detecting the endpoint of a polishing step. In general, an electropolishing system is provided with a power supply configured to deliver a current through an electrolytic solution. The current is monitored and related to the total removal of material from a substrate to determine the end point of the polishing cycle.

The words and phrases used herein should be given their ordinary and customary meaning in the art by one skilled in the art unless otherwise further defined. Chemical-mechanical polishing should be broadly construed and includes, but is not limited to, abrading a substrate surface by chemical activities, mechanical activities, or a combination of both chemical and mechanical activities. Electropolishing should be broadly construed and includes, but is not limited to, planarizing a substrate by the application of electrical and/or electrochemical activity. Electrochemical mechanical polishing (ECMP) should be broadly construed and includes, but is not limited to, planarizing a substrate by the application of electrochemical activity, mechanical activity, or a combination of both electrochemical and mechanical activity to remove materials from a substrate surface. Electrochemical mechanical plating process (ECMPP) should be broadly construed and includes, but is not limited to, electrochemically depositing material on a substrate and concurrently planarizing the deposited material by the application of electrochemical activity, mechanical activity, or a combination of both electrochemical and mechanical activity.

Anodic dissolution should be broadly construed and includes, but is not limited to, the application of an anodic bias to a substrate directly or indirectly which results in the removal of conductive material from a substrate surface and into a surrounding electrolyte solution.

Embodiments of the invention broadly provide for endpoint detection in a polishing system. In general, any of the above-defined polishing techniques may be used, individually or in combination. Further, it is contemplated that polishing and plating may occur simultaneously or alternately. The foregoing embodiments are broadly characterized as electropolishing.

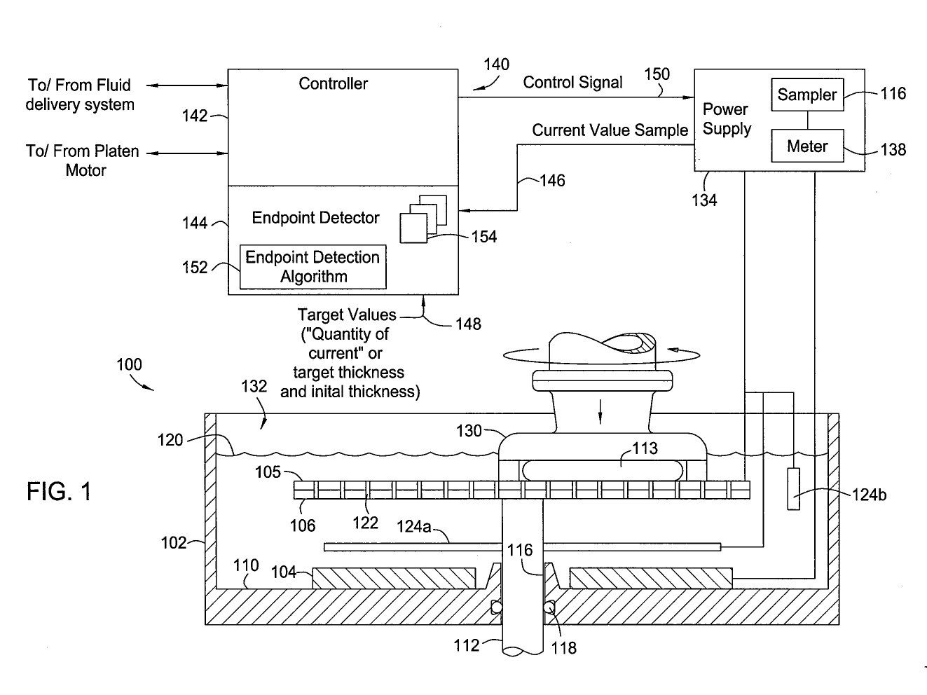

FIG. 1 depicts an electrochemical mechanical polishing (ECMP) station 100, which may be a component of a larger platform or tool. One polishing tool that may be adapted to benefit from the invention is a REFLEXTION® chemical mechanical polisher available from Applied Materials, Inc. located in Santa Clara, Calif.

Generally, the electrochemical mechanical polishing (ECMP) station 100 comprises a polishing head 130 adapted to retain the substrate 113. The polishing head 130 may be mounted to a carousel (not shown) which operates to rotate the polishing head 130 to a position over various stations, including the ECMP station 100. Examples of embodiments of polishing heads 130 that may be used with the polishing apparatus 100 described herein are described in U.S. Pat. No. 6,024,630, issued Feb. 25, 2000 to Shendon, et al. One particular polishing head that may be adapted to be used is a TITAN HEAD™ wafer carrier, manufactured by Applied Materials, Inc., located in Santa Clara, Calif.

The ECMP station 100 further includes a basin 102, an electrode 104, polishing article 105 and a pad support disc 106. The basin 102 generally defines a container or electrolyte-containing volume 132 in which a conductive fluid such as an electrolyte 120 can be confined and in which the electrode 104, polishing article 105, and disc 106 are generally housed. The electrolyte 120 used in processing the substrate 113 can electrochemically remove metals such as copper, aluminum, tungsten, gold, silver or other conductive materials. Accordingly, the basin 102 can be a bowl-shaped member made of a plastic such as fluoropolymers, TEFLON®, PFA, PE, PES, or other materials that are compatible with electroplating and electropolishing chemistries.

The basin 102 has a bottom 110 that includes an aperture 116 generally disposed in the center of the bottom 110 and allows a shaft 112 to pass therethrough. A seal 118 is disposed between the aperture 116 and the shaft 112 and allows the shaft 112 to rotate while preventing fluids disposed in the basin 102 from passing through the aperture 116. Rotation is imparted to the shaft 112 by a motor (not shown) connected to a lower end of the shaft 112. The motor may be an actuator capable of rotating the shaft at a predefined speed or speeds.

At an upper end, the shaft 112 carries the pad support disc 106. The pad support disc 106 provides a mounting surface for the polishing article 105, which may be secured to the disc 106 by a clamping mechanism or an adhesive (such as a pressure sensitive adhesive). Although shown connected to the shaft 112, in another embodiment, the disc 106 can be secured in the basin 102 using fasteners such as screws or other fastening means, thereby eliminating the need for the shaft 112. The disc 106 can be spaced from the electrode 104 to provide a better electrolyte recirculation.

In one embodiment, the disc 106 may be made from a material compatible with the electrolyte 120 which would not detrimentally affect polishing. Illustratively, the disc 106 may be fabricated from a polymer, for example fluoropolymers, PE, TEFLON®, PFA, PES, HDPE, UHMW or the like. In one embodiment, the disc 106 includes a plurality of perforations or channels formed therein. The perforations are coupled to the perforations of the polishing article 105 which, cooperatively, define channels 122 extending from a lower surface of the disc 106 to an upper surface of the polishing article 105. The provision of the channels 122 makes the disc 106 and the polishing article 105 generally permeable to the electrolyte 120. The perforation size and density is selected to provide uniform distribution of the electrolyte 120 through the disc 106 to the substrate 113.

The polishing article 105 can be a pad, a web or a belt of material, which is compatible with the fluid environment and the processing specifications. The polishing article 105 is positioned at an upper end of the basin 102 and supported on its lower surface by the disc 106. Preferably, the polishing article 105 includes polishing material to effect mechanical polishing of the substrate 113, although mechanical polishing may also be achieved by the addition of an abrasive to the electrolyte 120. In still other embodiments, the ECMP station 100 is operated to provide electropolishing, with or without mechanical polishing. As such, a current must be provided to the substrate surface. To this end, the ECMP station 100 is equipped with a power supply 134 electrically coupled to a pair of electrodes: the substrate 113 and the counter-electrode 104. The manner in which a terminal of the power supply 134 is coupled to the substrate 113 may be any of a variety, and is not limiting of the invention. In one particular embodiment, the polishing article 105 is made conductive and coupled to the power supply 134. In this manner, a current may be provided through the substrate 113 by contacting a conductive surface of the substrate 113 with the conductive polishing article 105.

As such, in one embodiment, the polishing article 105 includes at least a partially conductive surface for contact with the substrate surface during processing. Generally, the polishing article 105 may be a conductive polishing material or a composite of a conductive material disposed in a polishing material (where, in some cases, the conductive material may also be responsible for performing mechanical polishing). The conductive material may also be inserted between the disc 106 and polishing material 105 with some conductive ends for contact with the substrate 113 during polishing. The conductive materials and the polishing materials preferably have mechanical properties which do not degrade under sustained electric fields and are resistant to degradation in acidic or basic electrolytes.

The conductive polishing material may include conductive polymers, polymer composites with conductive materials, conductive metals, conductive fillers or conductive doping materials, or combinations thereof. Conductive polymers include polymeric materials that are intrinsically conductive, such as polyacetylene, polyethylenedioxythiophene (PEDT), which is commercially available under the trade name Baytron™, polyaniline, polypyrrole, and combinations thereof.

The polymer composites with conductive materials may include polymer-noble metal hybrid materials. Polymer-noble metal hybrid materials that may be used as the conductive polishing material described herein are preferably chemically inert with a surrounding electrolyte, such as those with noble metals that are resistant to oxidation. An example of a polymer-noble metal hybrid material is a platinum-polymer hybrid material. The invention also contemplates the use of polymer-noble metal hybrid materials, which are chemically reactive with a surrounding electrolyte, when the polymer-noble metal hybrid material is insulated from a surrounding electrolyte by another material.

Conductive metals that may be used as the polishing material are those metals that are preferably relatively inert to chemical reactions with the surrounding electrolyte. Platinum is an example of a conductive metal that may be used as the polishing material. The conductive metals may form a portion or the entire polishing surface of the polishing material. When forming a portion of the polishing surface, the conductive metals are typically disposed in a conventional polishing material.

The conductive polishing materials may further include conductive fillers or conductive doping materials disposed in a binder material, such as the conductive polymers described above or a conventional polishing material. Examples of conductive fillers include carbon powder, carbon fibers, carbon nanotubes, carbon nanofoam, carbon aerogels, and combinations thereof. Carbon nanotubes are conductive hollow filaments of carbon material having a diameter in the nanometer size range. The conductive fillers or conductive doping materials are disposed in the binding material in an amount sufficient to provide a polishing medium having a desired conductivity. The binder material is typically a conventional polishing material.

Polishing materials may include polymeric materials, such as polyurethane, polycarbonate, polyphenylene sulfide (PPS), or combinations thereof, and other polishing materials used in polishing substrate surfaces. An exemplary conventional material includes those found in the IC series of polishing media, for example polyurethane and polyurethane mixed with fillers, commercially available from Rodel Inc., of Phoenix, Ariz. The invention further contemplates the use of other conventional polishing materials, such as a layer of compressible material. The compressible material includes a conventional soft material, such as compressed felt fibers leached with urethane.

Further, the invention contemplates the use of abrasive materials embedded in the conventional polishing material. The fixed abrasive particles may include conductive abrasive materials and/or nonconductive abrasive materials.

Alternatively, the polishing article 105 may comprise a metal mesh disposed in the polishing material. The metal mesh may comprise a chemically inert conductive material, such as platinum. The metal mesh may also include materials that have been observed to react with the surrounding electrolyte 120, such as copper, if the metal mesh is chemically insulated from the electrolyte such as by a conformal layer of conventional material.

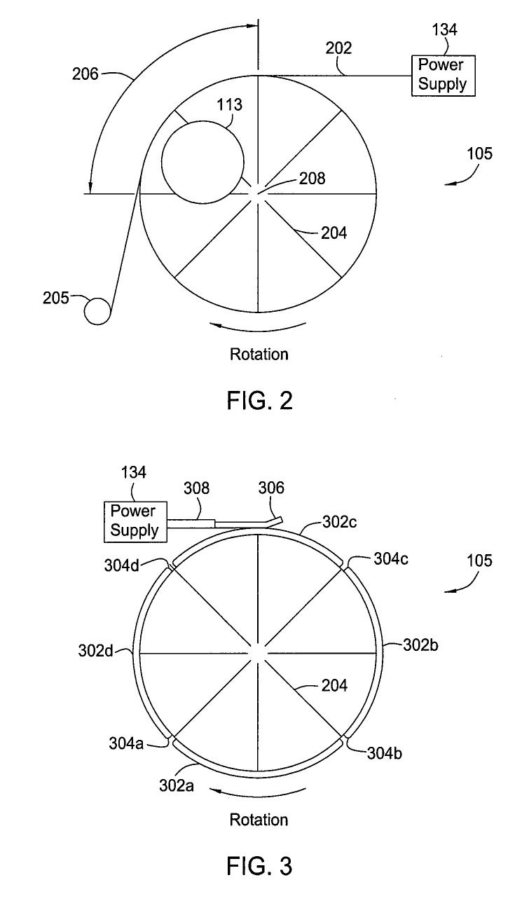

In some cases (where the polishing article 105 is conductive) it may be desirable to restrict current flow to those areas of the polishing article 105 which are in contact with the substrate 113. One embodiment suitable for providing power to selected areas of the polishing article 105 is described with reference to FIG. 2 which shows a top view of the polishing article 105. A power strip 202 and conducting members 204 (eight shown) are used to provide a current to the polishing article 105. The power strip 202 and the conducting members 204 may be of any sufficiently conductive material, such as copper. The power strip 202 is connected at one end to the power supply 134 and at another end to an anchor 205. The anchor may be any insulated member. Illustratively, a portion of the power strip (indicated by arc length 206) is wrapped around a circumferential edge of the polishing article 105. The conducting members 204 are generally radially disposed from a center 208 of the polishing article 105 to the edge of the conductive polishing article 105. The terminal ends of the conducting members 204 at the edge of the conductive polish article 105 are sufficiently exposed to make electrical contact with the conducting strip 202. To this end, the conducting members 204 may extend slightly beyond the edge of the polishing article 105. In this manner, the power strip 202 is capable of providing a current to any conductive element(s) 204 of the polishing article 105 with which it comes into contact with.

At least in one embodiment, the conducting members are electrically isolated from one another (note that in FIG. 2 the conducting members to not touch at the center of the polishing article 105). This allows, at any given time, some of the conducting members to be positively biased by contact with the power strip, while other conducting members are not biased. The fact is that of a “zone switch” which allows current to be selectively delivered depending on the rotation of the polishing article 105.

In operation, a substrate 113 is brought into contacting with the upper polishing surface of the polishing article 105 while the polishing medium is rotated about its center axis. In some embodiments, the substrate may be moved relative to the polishing article 105 by action of the polishing head 130. However, in order to ensure anodic dissolution, the substrate's position should be constrained to a region in which contact with one of the energized conducting members (that is, one of the conducting members currently in contact with the power strip) is made. Those conducting members not in direct contact with the power strip, or indirect contact with the power strip via the substrate, will not experience a positive bias, or at least a relatively smaller bias. As a result, electrochemical attack and damage of the conducting members and any conductive elements electrically connected thereto is reduced. In one embodiment, any one of the conductive members and power strip are electrically connected for between about 20% and 60% of the rotation period of the polishing article 105.

Typically, the highest potential on the energized conducting members is closest to the power strip and the lowest potential is at the end of the conducting members closest to the center of the polishing article 105. Accordingly, in order to ensure an equipotential surface along the length of the conducting members, and therefore over the surface of the contacting substrate, the conducting members may be of increasing conductivity from the edge of the polishing article 105 to the center 208. In some cases, substrate rotation relative to the polishing pad will equalize or average out the potential imparted to the substrate surface to provide for more uniform material deposition rate or removal rate.

Over time, the power strip contacting the edge of the polishing article 105 may become worn. Accordingly, it may be necessary to replace or recondition the power strip. To this end, the anchor 205 may be equipped with a power strip dispenser. A mechanism may be provided on the other end of the power strip to take up slack when a length of power strip is dispensed from the power strip dispenser.

FIG. 3 shows a top view of another embodiment of the polishing article 105 in which power is coupled from the power supply 134 to a substrate (not shown) being polished. As in the embodiment described above with reference to FIG. 2, the polishing article 105 includes a plurality of electrically isolated conducting members 204. A plurality of conductive ring portions 302A-D (four shown, by way of illustration) are disposed at the perimeter of the polishing area of the polishing article 105. The ring portions 302 are in electrical communication with the one or more conducting members 204. However, the ring portions 302 are isolated from one another by gaps 304A-D. Although not shown, in one embodiment insulating material is disposed within the gaps to prevent arcing between the ring portions. Periodic electrical contact is made between the ring portions 302 and the power supply 134 via a contact finger 306 connected to a flexible arm 308. The flexible arm 308 provides a mechanical bias against the ring portions 302 to ensure adequate contact. In one embodiment, the conductive ring portions are embedded within the perimeter edge of the polishing article 105, but exposed to allow contact with the contact finger 306.

In operation, a substrate is placed into contact with the upper polishing surface of the rotating polishing article 105. At any given time, a selective positive bias is provided to one or more of the conductive ring portions 302, and therefore, the associated (i.e. electrically connected) conducting members 204. To ensure anodic dissolution, the substrate is positioned to be in electrical contact with the appropriate conducting members 204. During rotation of the polishing article 105, one or more of the conducting members 204 will be positively biased, while the other conducting members will be unbiased. In this manner, electrochemical damage to any of the conducting portions of the polishing article 105 is reduced.

In any case (referring again to FIG. 1), where the polishing article 105 is at least partially conductive, the polishing article 105 acts as an electrode in combination with the substrate 113 during electrochemical processes. The electrode 104 is a counter-electrode to the polishing article 105 contacting a substrate surface. The electrode 104 may be an anode or cathode depending upon the positive bias (anode) or negative bias (cathode) applied between the electrode 104 and polishing article 105.

For example, depositing material from an electrolyte on the substrate surface, the electrode 104 acts as an anode and the substrate surface and/or polishing article 105 acts as a cathode. When removing material from a substrate surface, such as by dissolution from an applied bias, the electrode 104 functions as a cathode and the substrate surface and/or polishing article 105 may act as an anode for the dissolution process.

The electrode 104 is generally positioned between the disc 106 and the bottom 110 of the basin 102 where it may be immersed in the electrolyte 120. The electrode 104 can be a plate-like member, a plate having multiple holes formed therethrough or a plurality of electrode pieces disposed in a permeable membrane or container. A permeable membrane (not shown) may be disposed between the disc 106 and the electrode 104 to prevent particles or sludge from being released from the electrode 104 into the electrolyte. The permeable membrane may also act as a filter and prevent gas evolution from the counter electrode from reaching the substrate during processing. Pores size and density of the permeable membrane are defined in a way to optimize the process performances.

For electrochemical removal processes, such as anodic dissolution, the electrode 104 may include a non-consumable electrode of a material other than the deposited material, such as platinum for copper dissolution. However, the electrode 104 can also be made of copper for copper polishing, if preferred.

In one embodiment, the polishing station 100 includes a reference electrode. For example, a reference electrode 124A may be disposed between the disc 106 and the counter electrode 104. More generally, a reference electrode may be at any location in the basin as long as the reference electrode is submerged within the electrolyte 120. For example, a reference electrode 124B is shown suspended between a sidewall of the basin 102 and the polishing article 105. The reference electrode acts to maintain a constant electrochemical potential on the substrate. Accordingly, the provision of the reference electrode makes the removal rate independent from the changes in the conductivity in the current loop, which may caused by the deposition of loose copper on the counter electrode 104 for instance. The reference electrode may be made of a very thin metal wire, such as a wire made of platinum.

The polishing station 300 is energized by one or more power supplies, such as power supply 134. In one embodiment, the power supply 134 is a direct current (DC) power supply. However, the power supply 134 may also be an alternating current (AC) power supply. In one aspect, a DC power supply is preferred to avoid alternately removing and depositing material on a substrate. In general, the power supply 134 is capable of providing power between about 0 Watts and 100 Watts, a voltage between about 0V and 10V, and a current between about 0 amps and about 10 amps. However, the particular operating specifications of the power supply 134 may vary according to application.

The power supply 134 is particularly adapted to provide a current through the electrolyte 120. To this end, the power supply 134 is connected by a positive (+) terminal to a first electrode and by a negative (−) terminal to a second electrode. In one embodiment, the first electrode is a conducting portion of the polishing article 105, such as the conducting members 204. As a result, the first electrode is in direct contact with a substrate disposed on the polishing article 105, at least during part of a polishing cycle. The second electrode is the counter electrode 104 disposed on a floor of the basin 102, for example. In contrast to the first electrode, the second electrode need not be in direct physical contact with the substrate. In one embodiment, the power supply 134 is also connected a reference electrode 310A or 310B.

A plating or polishing process is performed by flowing a current from the power supply 134 through electrolyte 120. The electrolyte 120 may be a solution which includes commercially available electrolytes. For example, in copper containing material removal, the electrolyte may include sulfuric acid, sulfuric acid salt based electrolytes or phosphoric acid, phosphoric acid salt based electrolytes, such as potassium phosphate (K3PO4), (NH4)H2PO4, (NH4)2HPO4, or combinations thereof. The electrolyte may also contain derivatives of sulfuric acid based electrolytes, such as copper sulfate, and derivatives of phosphoric acid based electrolytes, such as copper phosphate. Electrolytes having perchloric acid-acetic acid solutions and derivatives thereof may also be used. Additionally, the invention contemplates using electrolyte compositions conventionally used in electroplating or electropolishing processes, including conventionally used electroplating or electropolishing additives, such as brighteners, chelating agents, and levelers among others. In one aspect of the electrolyte solution, the electrolyte may have a concentration between about 0.2 and about 1.2 Molar of the solution. Preferably, the electrolyte is selected to react with metal but not with the underlying materials, such as the dielectric.

The operation of the polishing system 100 is controlled by a control system 140. In one embodiment, the control system 140 includes one or more controllers (represented as controller 142) and an endpoint detector 144. The controller 142 is operably connected to one or more of the devices of the polishing system 100 such as, for example, the power supply 134, a fluid delivery system (not shown), a motor (not shown) for rotating the support disc 106, and the carrier head 130. The endpoint detector 144 is configured to monitor the current value samples 146 taken by an amp meter 138 of the power supply 134. The frequency with which samples are taken is determined by a sampler 136 of the power supply 134. In one embodiment, the sampler 136 may be user-configured with a desired frequency value. Alternatively, the current may be monitored as a continuous signal, rather than as discrete values.

The current value measurements taken from the meter 138 may then be used by the endpoint detector 144 to determine whether an endpoint has been reached based on a target quantity of current value 148, where the quantity of current is the total charge of the material removed from the substrate 113. In one embodiment, the target quantity of current value 148 is input to the endpoint detector 144 by an operator. If a polishing endpoint has been reached, the endpoint detector 144 may notify the controller 142, which may then issue one or more control signals (e.g., control signals 150 to the power supply 134) to initiate additional steps and/or halt the polishing of the substrate. Alternatively, the input to the endpoint detector 144 may be a target thickness a pre-measured initial thickness of a wafer to be polished until reaching the target thickness.

In operation, electrolyte 120 is flowed into the volume 132 of the basin 102. The electrolyte 120 fills the volume 132 and is thus brought into contact with the substrate 113 and polishing article 105. Thus, the substrate 113 maintains contact with the electrolyte 120 through the complete range of relative spacing between the cover 108 and the disc 106.

To initiate electrochemical mechanical processing, a potential difference is applied between two electrodes e.g., electrode 104 and the conductive portion of the polishing article 105. The substrate 113 being in direct contact with the conductive portion of the polishing article 105 will then be at the same potential as the conductive portion. The current loop is then completed in the polishing station by transforming atomic substrate materials into ions in the electrolyte 120. Concurrent mechanical polishing of the substrate 113 is achieved by relative movement between the substrate and the polishing article 105. Polishing continues until reaching an endpoint, as determined by the endpoint detector 144. In at least one embodiment, “endpoint” refers to a point in time during a polishing cycle at which sufficient bulk metal has been removed from a substrate. Following detection of the endpoint, it may be necessary to continue polishing for a period of time in order to remove residual metal.

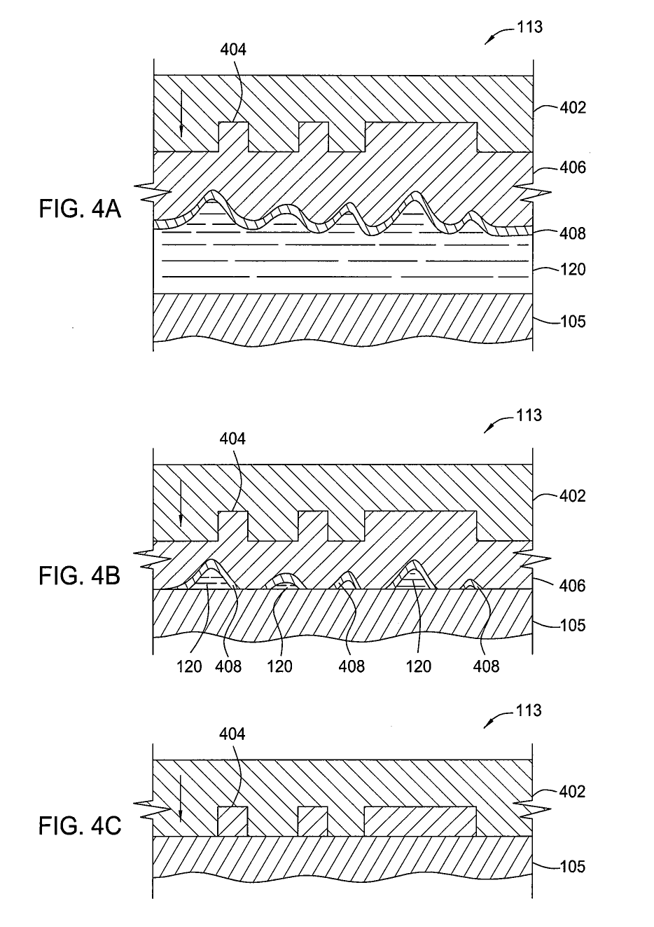

A polishing operation will now be described with reference to FIGS. 4A-C. However, it is understood that the following polishing operation is merely illustrative and not limiting of the invention since aspects of the invention may be applied to advantage regardless of the particular operation or material removal mechanism during electro-polishing of a substrate. Referring first FIG. 4A a side view of the substrate 113 and the polishing article 105 is shown. The polishing article 105 is shown submerged in the electrolyte 120 which is made an ionic conductor by application of a current from the power supply 134. The substrate 113 is shown located over the electrolyte 120 and moving downward toward the polishing article 105. In general, the substrate 113 includes a base material 402 (typically made of silicon) having features formed therein. The base material 402 may be covered by multiple layers of dielectric materials, semiconducting materials and conducting materials. The outermost metal layer 406 has been previously deposited in the features 404 and over the previous dielectric, semiconducting and conductive layers. Illustratively, the metal layer 406 is copper.

The polishing which occurs in electrochemical mechanical polishing is a combination of mechanical polishing (as a result of relative movement between the substrate 113 and the polishing article 105) and anodic dissolution (as a result of chemical interaction between the substrate 113 and the electrolyte 120). Since is desirable to selectively polish the peaks of the metal layer 406, a passivation layer 408 formed over the metal layer 406 is selected to ensure that polishing occurs primarily where contact is made with the polishing article 105. Passivation agents which are part of the conductive electrolyte will passivate the recessed areas of the incoming metal layer to be polished, and thereby prevent anodic dissolution in those areas. Thus, copper lines (i.e., the copper in the features 404 are not being polished due to the fact that they are protected by the passivation layer 408 and they are not in contact with the polishing article 105. Once the polishing article 105 removes the passivation layer 408 to expose the metal layer 406, both mechanical polishing and anodic dissolution can occur on the exposed metal layer 406. Accordingly, as shown in FIG. 4B, the passivation layer 408 is not present at the interface of the polishing article 105 and the metal layer 406. Illustrative passivation agents include BTA, TTA, etc.

Polishing continues until the excess bulk metal has been removed, at which time the endpoint detector 144 indicates to the controller 142 that a polishing endpoint has been reached. FIG. 4C is illustrative of a surface condition of the substrate at a polishing endpoint. Copper lines (i.e., the copper in the features 404) are not being polished due to the fact that they are protected by the passivation agent and they are not in contact with the polishing article 105. In one embodiment, polishing is allowed to continue for some period of time in order to ensure adequate removal of metal residues. This phase of polishing is referred to herein as “over polishing”. Because the polishing endpoint has already been detected, over polishing can be carefully timed and controlled to minimize copper dishing and optimize wafer throughput.

To determine the occurrence of an endpoint of a polishing cycle, the endpoint detector 144 shown in FIG. 1 is configured with an endpoint detection algorithm 152. The endpoint detection algorithm 152 (and, more generally, the endpoint detector 144 itself may be implemented by hardware, software, or a combination of both. Accordingly, one embodiment of the invention is implemented as a program product for use with a computer system such as, for example, the system 140 shown in FIG. 1. In this regard, the system 140 may be representative of, or include, a computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. The program(s) of the program product defines functions of the preferred embodiment and can be contained on a variety of signal-bearing media (or computer readable media), which include, but are not limited to, (i) information permanently stored on non-writable storage media, (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

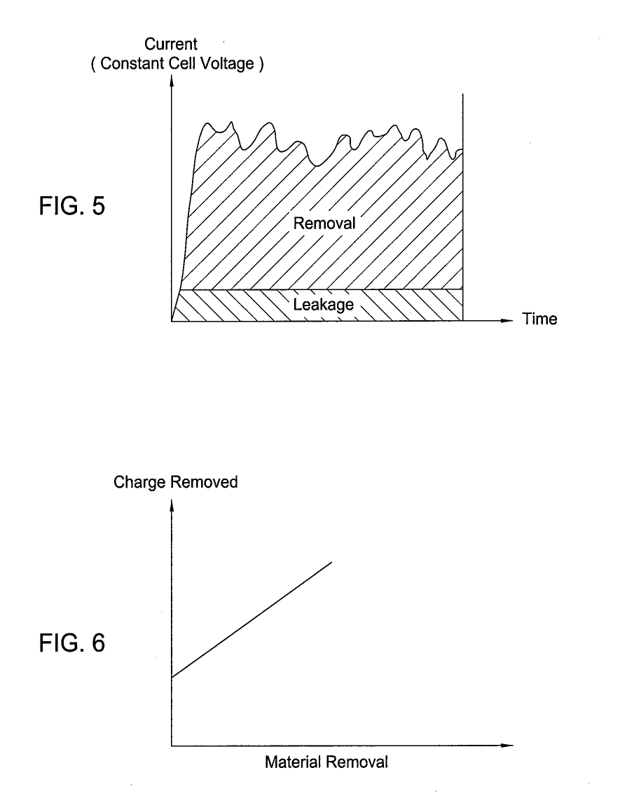

In a particular embodiment, the endpoint detection algorithm 152 calculates the total charge removed from a wafer. This is done by integrating, with respect to time, the total current signal provided to the cell/wafer for polishing (herein referred to as the total current signal or cell current signal). Recognizing that the area under the cell current signal (given by the integral of the cell current signal) gives the material removed and any leakage current (as represented by FIG. 5), a polishing endpoint can be determined by relating the total charge removed (the integral of the cell current signal corrected for any leakage) to the total material removed. A graphical representation of such a relationship is generically described by the plot line of FIG. 6. As will be described in more detail below, this charge/removal relationship may be theoretically or empirically determined. Detection of the endpoint for a polishing cycle of a wafer then requires knowing only the initial thickness of the wafer prior to polishing. The wafer is polished until the difference between the initial wafer thickness and the removed thickness is equal to the desired thickness:
Target Thickness=Initial Thickness−Thickness of Removed Material (Equation 1)

Where the “Thickness of Removed Material” is a function of the quantity of current, which is given by the integral of the current (which may be corrected for any leakage current, as described below). Where the current signal is only periodically sampled (i.e., where the endpoint detection algorithm 152 uses the current value samples 146 received from the meter 138 of the power supply 134), the integral is approximated as a sum:
Quantity of Current(t)=integral(0,t)[l(t)dt]{sum(0,t)[l(t)*(sampling period)] (Equation 2)

Having calculated the sum of the current values over time (i.e., total charge removed), the “Thickness of Removed Material” can be determined with reference to the predetermined the charge/removal relationship. In one embodiment, the charge/removal relationship is stored in data structures such as lookup tables 154. Thus, the lookup tables 154 relate a value calculated by the endpoint detection algorithm 152 (i.e., total charge removed determined by summation, as described above with reference to Equation 2) to the total material removed from a substrate. A separate lookup table 154 may be provided for each of a variety of processing conditions and substrate types. For example, separate lookup tables 154 may be provided for patterned and unpatterned substrates. The lookup tables 154 may be further characterized by electrolyte composition, the type of material to be removed, etc. In this manner, the endpoint detector 144 is adaptable for detecting the endpoint of a polishing cycle for a variety of processing conditions and substrate types.

Thus, in one embodiment, the endpoint detection algorithm 152 calculates the integral of the current signal and then accesses the appropriate lookup table 154 to determine the corresponding amount of material removed.

While aspects of the invention are described with respect to lookup tables 154, it should be understood that such tables are merely representative of one embodiment. More generally, any technique whereby a calculated total charge value is correlated to total material removed may be used to advantage.

In general, the lookup tables 154 may be populated using theoretically derived information or empirically derived information. In either case, in electrochemical mechanical polishing, the current measured in the cell (i.e., the total/cell current) is related to the metal (e.g., copper) removal. The cell (total) current is composed of: (i) leakage current; and (ii) metal removal on the wafer (i.e., the actual removal process which may be, for example, Cu+/Cu++/CuComplex removal). Leakage current may generally be characterized as the noneffective current and its sources include the chemical reaction of contact members (e.g., contact members 204) and the different oxidations which may occur. The first type of leakage current can be substantially eliminated where a zone switch is used (such as the ones described above with reference to FIGS. 2 and 3). The significance of the second type of leakage current is dependent upon the particular polishing reaction. In the case of copper polishing, the potential for copper oxidation is greater then the potential of the reaction of oxygen evolution. Thus, when there is competition between these two oxidation reactions, most of the current goes to copper oxidation. Accordingly, leakage current due to oxygen evolution on the wafer can be neglected where copper is being polished. In any case, the leakage current can be calibrated easily using a silicon wafer. This will give a relationship between the leakage current and the voltage applied to the cell.

Having determined (or neglecting) the leakage current, the total current can be known by determining the contribution of metal removal on the wafer. Then, the total current over time and the removal rate over time can be expressed as total charge removed and total material removed for a point in time. This can be done theoretically or empirically, as will now be described. By way of illustration only, the material to be polished is assumed to be copper. It is understood that the invention may be used to advantage with any other conducting material.

Theoretically Derived Current/Removal Rate and Charge/Removal Relationship

The current/removal rate relationship can be described as follows: Current->Charge per unit time->Atoms removed per unit time->removal rate on the wafer.

The current/removal rate relationship may be different depending on whether the wafer is a blanket wafer or a patterned wafer and depending on chemistry. In any case, the current/removal rate relationship can be obtained theoretically if the reaction scheme is known. For example, assume that it is known that only Cu++ (and not Cu+) is removed for a given process. Assume further that a uniform removal rate of 1000 Å/min over a 200 mm wafer (surface area=314 cm2) has been measured for a wafer. It is known that for a copper crystal: a=b=c=361.49 pm=3.6149 Å. Thus, the volume of a unit cell is 47.23 Å3. Since there are four (4) atoms in a unit cell and two (2) charges per unit cell, the total charge per unit cell removed is: 4atoms*2charges*1.6e−19 C. Further, since the volume of 1000 Å is 314e19 Å3, the number of unit cells per 1000 Å is 314*e19/47.23=6.64e19. The total charge removed is therefore 6.64e19*(4atoms*2charges*1.6e−19 C)=85 C/min. Accordingly, a removal rate of 1000 Å/min corresponds to 1.42 Amps of Cu++ current. For a 200 mm wafer, then, the current/removal relationship is 1.4 Amps per kAngstrom/min. In this manner, the current/removal rate relationship may be determined for a desired range of current values and removal rates.

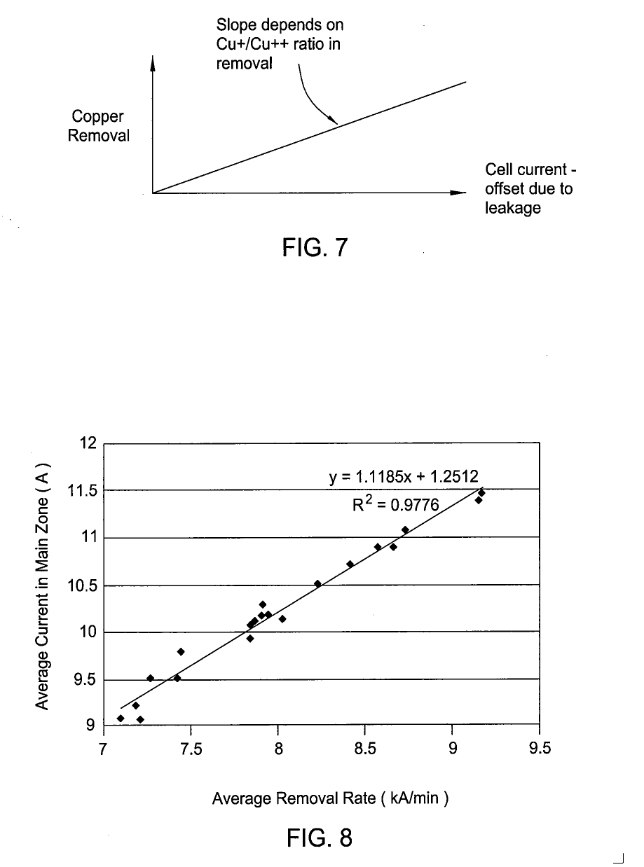

An illustrative current/removal rate relationship is expressed by the linear plot line 700 of FIG. 7, where the y-axis is the removal rate of copper and the x-axis is the total current (offset due to leakage current). Note that the relationship is substantially linear. Thus, the plot line 700 is described by y=mx+b, where m is the slope of the line. The slope of the line depends on the oxidation processes taking place. For example, where Cu+ and Cu++ removal occur, the slope depends on the Cu+/Cu++ removal ratio. By way of illustration, recall that it was calculated above that where removal is purely Cu++, the current is 1.42 Amps per kAngstrom/min. It can similarly be calculated that where the removal is purely Cu+ the current is 0.71 Amps per kAngstrom/min. Thus, if the removal involves both Cu+ and Cu++, the current/removal rate relationship will be between 0.71 and 1.42 Amps per kAngstrom/min. Ultimately, the effective current will depend upon the particular chemistry being employed.

Having established the relationship between cell current and removal rate, it remains only to establish a meaningful application of this relationship for determining the endpoint of a polishing cycle. As described above, the endpoint is determined by calculating the total charge removed from measured current values. Accordingly, what is needed is to relate the total charge removed to the total material removed at a given time. Since a theoretical relationship between cell current and removal rate has been established according to the method described above, the derived relationship can be readily expressed as total charge removed and total material removed, as illustrated generically by FIG. 6. The relationship between the total charge removed and total material removed is then used to populate the lookup tables 154, which are used by the endpoint detection algorithm 152 to determine the amount of material removed at a given point in time and, hence, the endpoint of a polishing cycle. More specifically, the thickness can be known by measuring current values over time and solving the following equation (which is a particular instance of Equation 1):
Thickness(t)=Initial_Thickness−Sum(0,t)[(Current(t)−Leakage(V(t)))*Current_To_Removal_Coefficient] (Equation 3),
where the Current_To_Removal_Coefficient is the slope (“m”) of the current/removal rate curve (e.g., plot 700 of FIG. 7) and leakage is a constant (“b”). Thus, the values “m” and “b” for different processes/wafers can be stored in lookup tables, which are then accessed for a given process to retrieve the appropriate values for “m” and “b”.

If the wafer is patterned, a density coefficient is needed to take into account that if the selectivity is 100%, removal occurs only in the elevated areas. The density coefficient can be a function of the copper thickness for a variety of reasons including the initial height differences between all the protrusions and the different speeds at which the features are planarized. Further, since the elevated areas diminish with polishing the density approaches 1 with time as the profile is flattened. Thus, the coefficient 1/Density(Thickness(t)) can be used to correct the thickness estimation of a patterned wafer:
Thickness(t)=Initial_Thickness−Sum(0,t)[(Current(t)−Leakage(V(t)))*Current_To_Removal_Coefficient/Density(Thickness(t))] (Equation 4)

Thus, it can be seen that Equation 4 is a more general equation than Equation 3, since the coefficient 1/Density(Thickness(t)) goes to one (1) for a blanket wafer, in which case Equation 3 and Equation 4 are equal. Again, the coefficients and the leakage current needed to solve for thickness using Equation 4 can be stored in the lookup tables 154.

Empirically Derived Current/Removal Rate and Charge/Removal Relationship

In an alternative embodiment, the current/removal rate and charge/removal relationship is determined empirically. For example, the amount of material removed from a wafer can be measured periodically (e.g., by sheet resistivity measurements) while operating the power supply 134 in the current mode.

Alternatively, the current may be measured for a series of wafers processed at different conditions (e.g., slightly different polishing times, voltage biases, etc.). In this manner, a calibration curve can be acquired. One such calibration curve 800 is shown in FIG. 8. In this case, 20 wafers were polished under different conditions and the average current was recorded. The thicknesses of the wafers were measured before and after the polishing cycle to determine the average removal rate. The calibration curve (expressed as y=1.1185x+1.2512) exhibits a linear relationship between the average current and the average removal rate and allows for the prediction (by extrapolation) of a removal rate for a given current.

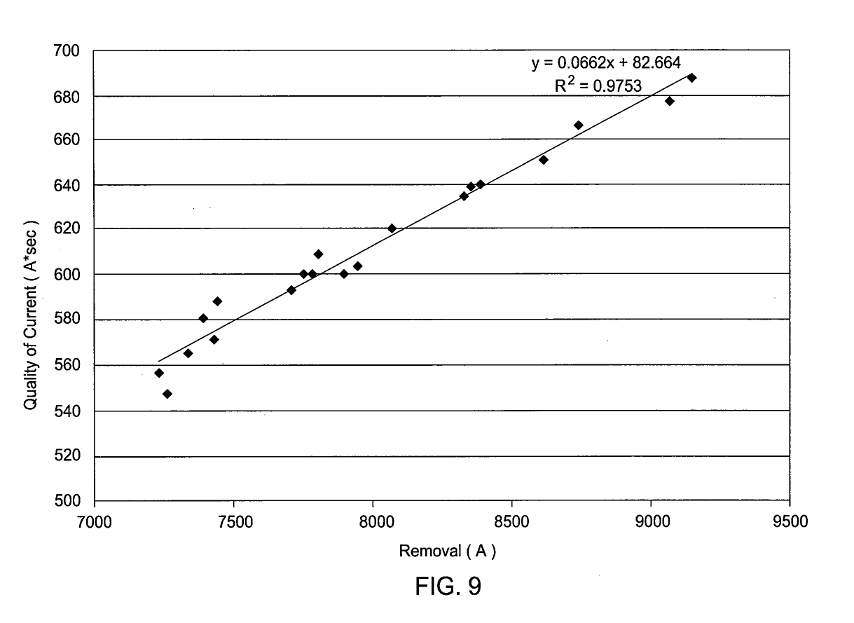

Having established a relationship between current and removal rate, it now remains to establish a relationship between the total charge removed (given by the sum of measured current values, as described with reference to Equation 2) and the thickness of the material removed. FIG. 9 shows one example of an empirically determined curve relating total charge (referred to Quantity of Current (A*sec) on the x-axis) and material removed (referred to as Removal on the y-axis). The information of FIG. 9 is used to populate a lookup table 154.

In operation, a total charge value is calculated using the periodically measured current values. The appropriate lookup table 154 is then accessed to determine the thickness of removed material. The endpoint detection algorithm then determines whether a target thickness (or a target total charge) has been reached. If so, the polishing process is halted and the substrate is removed from the cell.

Persons skilled in the art will recognize that the foregoing embodiments are merely illustrative. The invention contemplates and admits of many other embodiments. For example, a number of the foregoing embodiments described a face down electropolishing technique. That is, the substrate to be processed is in a face down orientation relative to the polishing pad. However, in other embodiments, face up electropolishing techniques are employed. These and other embodiments are considered within the scope of the invention.

While the foregoing is directed to embodiments of the present invention, other and further embodiments of the invention may be devised without departing from the basic scope thereof, and the scope thereof is determined by the claims that follow.

What is claimed is:

1. A method for determining an amount of material removed from a substrate, comprising:
providing a counter electrode;
providing a conductive polishing article disposed over the counter electrode;
contacting the substrate with the conductive polishing article so that the substrate is electrically connected to the conductive polishing article;
distributing an electrolyte to the substrate and the counter electrode;
polishing one or more conductive materials on the substrate by applying a bias between the conductive polishing article and the counter electrode;
determining a total charge removed from the substrate; and
correlating the total charge removed and a thickness of material removed from the substrate.

2. The method of claim 1, wherein the conductive polishing article comprises a conductive top surface for contacting the substrate.

3. The method of claim 1, wherein the conductive polishing article comprises an at least partially conductive polishing surface for contacting the substrate.

4. The method of claim 1, wherein the polishing article comprises conductive polymers, polymer composites with conductive materials, conductive metals, conductive fillers, conductive doping materials, or combinations thereof.

5. The method of claim 1, wherein correlating the total charge removed to the thickness of material removed from the substrate comprises accessing a data structure containing a predetermined relationship between the total charge removed and the thickness of material removed.

6. The method of claim 1, wherein determining a total charge removed from the substrate comprises:
periodically measuring a total current provided to the substrate over time;
subtracting, from each measured total current value, a leak current to determine a plurality of effective current values; and
summing the plurality of effective current values.

7. The method of claim 1, wherein determining a total charge removed from the substrate further comprises calibrating a leakage current to get a relationship between the leakage current and the bias applied between the conductive polishing article and the counter electrode.

8. The method of claim 1, further comprising causing relative motion between the substrate and the conductive polishing article during polishing the one or more conductive materials on the substrate.

9. A method for determining an end point of a polishing cycle for a substrate, comprising:
providing a conductive polishing article having a conductive top surface;
providing a counter electrode disposed under the conductive top surface of the conductive polishing article;
contacting the substrate with the conductive top surface of the conductive polishing article so that the substrate is electrically connected to the conductive polishing article;
distributing an electrolyte to the substrate and the counter electrode;
polishing one or more conductive materials on the substrate by applying a power supply between the conductive polishing article and the counter electrode; and
determining the end point of the polishing cycle for the substrate, the determining the end point comprising:
determining a total charge removed from the substrate during the polishing cycle;
correlating the total charge removed to a thickness of material removed from the substrate; and
determining whether a pre-measured initial thickness of the substrate, less the thickness of material removed, is equal to or less than a selected target thickness of the substrate.

10. The method of claim 9, wherein the conductive top surface comprises conductive polymers, polymer composites with conductive materials, conductive metals, conductive fillers, conductive doping materials, or combinations thereof.

11. The method of claim 9, wherein determining the total charge removed from the substrate comprises measuring a total current provided to the substrate over time.

12. The method of claim 9, wherein determining a total charge removed from the substrate comprises:
periodically measuring a total current provided to the substrate over time;
subtracting, from each measured total current value, a leakage current to determine a plurality of effective current values; and
summing the plurality of effective current values

13. The method of claim 9, wherein correlating the total charge removed to the thickness of material removed from the substrate comprises accessing a data structure containing a predetermined relationship between the total charge value and the thickness of material removed.

14. The method of claim 9, wherein determining a total charge removed from the substrate further comprises calibrating a leakage current to get a relationship between the leakage current and the bias applied between the conductive polishing article and the counter electrode.

15. A computer readable medium containing a program which, when executed, performs an operation during an electropolishing process the operation comprising:
polishing one or more conductive material on a substrate by providing an electrical signal to the substrate, wherein providing the electrical signal comprises:
applying the electrical signal between a counter electrode and a conductive polishing article;
contacting the substrate with the conductive polishing article; and
distributing an electrolyte to the substrate, conductive polishing article and the counter electrolyte;
summing a plurality of measured current values of the electrical signal provided to the substrate to calculate a total charge value, wherein the measured current values correspond to measurements made periodically since initiating a polishing cycle for the substrate; and
using the total charge value to determine a thickness of material removed from the substrate during the polishing cycle.

16. The computer readable medium of claim 15, wherein using the total charge value to determine the thickness of material removed comprises accessing a data structure relating the total charge value to a thickness value.

17. The computer readable medium of claim 15, wherein using the total charge value to determine the thickness of material removed comprises accessing a data structure containing a predetermined relationship between the total charge value the thickness of material removed.

18. The computer readable medium of claim 15, the operation further comprising detecting an endpoint of the polishing cycle.

19. The computer readable medium of claim 17, wherein detecting the endpoint of the polishing cycle comprises determining whether a pre-measured initial thickness of the substrate, less the thickness of material removed, is equal to or less than a selected target thickness of the substrate.

20. The computer readable medium of claim 17, wherein the operation further comprises initiating a continuing polishing step upon detection of the polishing endpoint.
